(19) United States
(12) Patent Application Publication
(10) Pub. No.: US 2017/0182834 A1
(43) Pub. Date: Jun. 29, 2017

(54) DEVICE AND METHOD FOR ENCODING WRITTEN INFORMATION

(71) Applicant: INTERNATIONAL BUSINESS MACHINES CORPORATION, Armonk, NY (US)

(72) Inventors: Tamer E. Abuelsaad, Somers, NY (US); Jason L. Crawford, Yorktown Heights, NY (US); Jonathan Lenchner, North Salem, NY (US)

(21) Appl. No.: 15/198,745

(22) Filed: Jun. 30, 2016

Related U.S. Application Data
(62) Division of application No. 14/982,383, filed on Dec. 29, 2015.

(51) Int. Cl. B43K 29/08; B43K 5/14

(52) U.S. Cl. CPC B43K 29/08; B43K 5/145

(57) ABSTRACT

Disclosed is a device for encoding information written on a readable surface, the device including a device housing containing at least one ink reservoir, an ink dispensing tip in communication with said at least one ink reservoir; and ink stored in the at least one ink reservoir and configured to flow from the ink dispensing tip, the ink being encodable to include supplemental encoded information, the supplemental encoded information being detectable by at least one detecting sensor when dispensed on the readable surface, wherein the readable surface is any surface that will accept the ink.

### CROSS-REFERENCE TO RELATED APPLICATION

This application is a divisional application and claims the benefit of priority to U.S. application Ser. No. 14/982,383, which was filed on Dec. 29, 2015. The entire contents of U.S. application Ser. No. 14/982,383 are incorporated herein by reference.

### BACKGROUND

The present invention relates to a device and method for encoding written information on a readable surface, and more specifically, to a device and method for encoding supplemental information in a written message on any readable surface.

In meetings and other settings, while a person is taking notes it is often useful to capture and record contextual or auxiliary information for later retrieval and analysis. In addition, automated assemblage of notes from a group of note-takers can be a useful artifact for the group during later discussions.

By way of example, useful auxiliary information from an individual note-taker or group of note-takers may include location, pen/author identification, time of day, synchronized strokes, audio/video sequence, stroke signature, etc. Some current generation “smart” pens capture audio, support electronic archiving, and synchronized audio and inking playback, including contextual playback triggered by tapping a pen on handwritten text. However, these current generation pens typically require tracking devices or pads of specialized paper with which the smart pen must be used in order to function properly.

Accordingly, a writing device capable of encoding information in handwritten text without the use of excessive auxiliary equipment and supplies (such as “smart” paper, including the type that may include readable, non-repeating dot patterns) would be desirable.

### SUMMARY

Disclosed is a device for encoding information written on a readable surface, the device including a device housing containing at least one ink reservoir, an ink dispensing tip in communication with said at least one ink reservoir; and ink stored in the at least one ink reservoir and configured to flow from the ink dispensing tip, the ink being encodable to include supplemental encoded information, the supplemental encoded information being detectable by at least one detecting sensor when dispensed on the readable surface, wherein the readable surface is any surface that will accept the ink.

Also disclosed is a method for encoding information written on a readable surface, the method including encoding ink in a writing device to include supplemental encoded information, dispensing the ink from said writing device onto the readable surface with the supplemental encoded message, the readable surface being any surface that will accept the ink, and detecting the supplemental encoded information via at least one detecting sensor disposed with or remote of the writing device.

A system for encoding written information, the system including a standard writing surface, and a writing device including a device housing containing at least one ink reservoir, an ink dispensing tip in communication with the at least one ink reservoir, and ink stored in the at least one ink reservoir and configured to flow from the dispensing tip, the ink being encodable to include supplemental encoded information, the supplemental encoded information being detectable by at least one detecting sensor when dispensed on the readable surface, wherein the readable surface is any surface that will accept said ink.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings (the relative sizes of the components shown in the diagrams being exemplary and/or schematic in nature, and not necessarily indicative of actual relative component size) in which:

FIG. 1 is a schematic view of a device for encoding written information in accordance with an exemplary embodiment;

FIG. 2 is a plan view of a readable surface including written text in ink dispensed from the device for encoding written information;

FIG. 3 is a plan view of a readable surface including written text with an encoded message provided in ink dispensed from the device for encoding written information;

FIG. 4 is another schematic view of a device for encoding written information in accordance with another exemplary embodiment; and

FIG. 5 is a block diagram showing a method for encoding written information in accordance with an exemplary embodiment.

### DETAILED DESCRIPTION

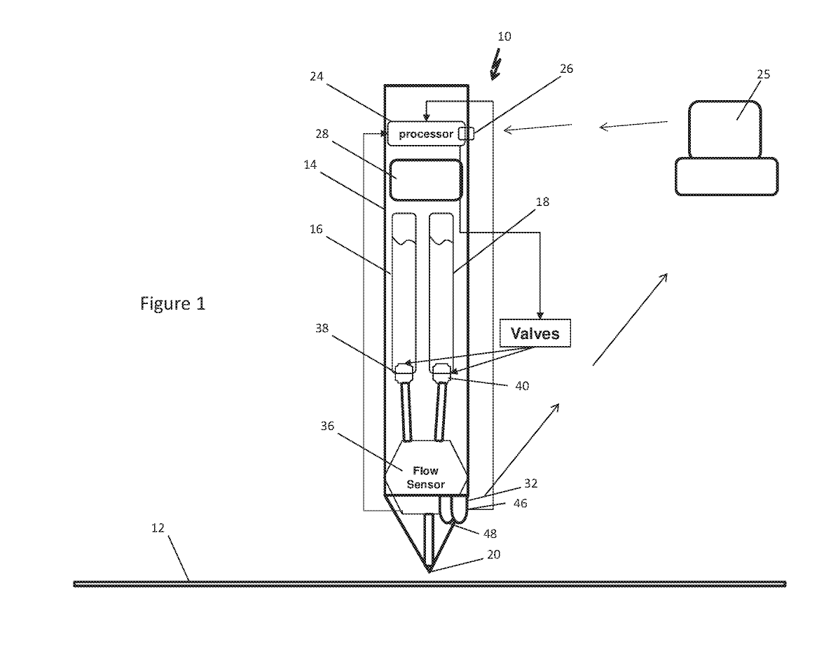

With reference now to FIG. 1, an exemplary embodiment of a writing device 10 for encoding supplemental information in a written message on a readable surface 12 is illustrated. The writing device 10 includes a device housing 14, a standard ink reservoir 16, and an encoding ink reservoir 18 including encodable ink. As used herein, “standard” ink will be defined as any ink that might be included in a standard non-smart pen or marker, such as any well-known ink solution that may include fine pigment particles dispersed in a solvent and/or dye. For purposes of this exemplary embodiment, the encodable ink reservoir 18 will be discussed as being inclusive of ultraviolet (UV) or infrared (IR) inks (which may be any ink that includes UV or IR pigments or dyes) that reflect wavelengths of visible light non-preferentially, but reflect or fluoresce UV and/or IR radiation only in selected bands. However, UV and IR inks are just examples of the types of encodable inks that may be used. It should be appreciated that standard ink in the standard ink reservoir 16 and encodable ink in the encoding ink reservoir 18 may appear the same to the unaided human eye when dispensed onto the readable surface 12.

Connected to the standard and encodable ink reservoirs 16 and 18 is an ink dispensing tip 20. Ink stored in the reservoirs 16 and 18 flows to the dispensing tip 20 for dispensing on the readable surface 12. Notably, ink dispensed from the encoding ink reservoir 18 is dispensable with supplemental encoded information that is supplemental to the writing (i.e. human hand written message, scribble, or any other kind of marking) dispensed on the readable surface 12. These supplemental encoded information may be invisible, partially visible, or wholly visible to the unaided human eye, and are also detectable by a detecting sensor 32 attached to, or remote from, the writing device (attached in FIG. 1) after the encoded ink is dispensed on the readable surface 12. The manner in which this dispensing of ink with a supplemental encoded information occurs will be discussed in greater detail below.

As shown in FIG. 1, the writing device 10 includes a processor 24 that may be programmed to control the dispensing of the encoded ink and any supplemental encoded information therein. The processor 24 is pre-programmed with or receives encoding data via a data receiver 26 or input and/or display component 28 on the writing device 10. If received via the data receiver 26, this data may be transmitted from a remote auxiliary computing device 25 (wirelessly or via a network connection), or input directly into the input and/or display component 28 on the writing device 10, and includes instructions regarding information to be encoded during the process of dispensing the encodable ink. If desired, instruction as to how to obtain such information from other systems may also be included in the data.

Via pre-programming with encoding data or receipt of encoding data, the processor 24 controls one or more dispensing parameters pertaining to flow of ink from the standard and encoding ink reservoirs 16 and 18 to the readable surface 12 via the dispensing tip 20. The processor 24 controls the ink dispensing parameters based on the encoding data received, with the supplemental encoded information being determined (including presence of supplemental encoded information at all) via dispensing parameter(s) implemented by the processor 24. This control by the processor 24 occurs in conjunction with a flow sensor 36 and dispensing valves 38 and 40 discussed in greater detail below.

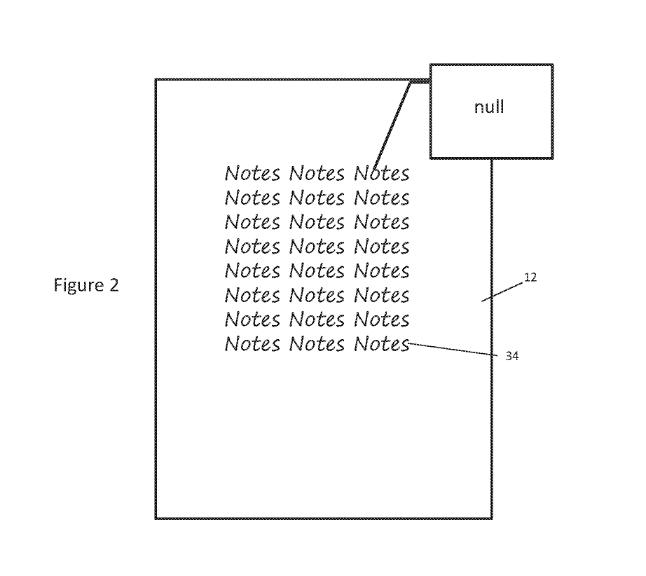

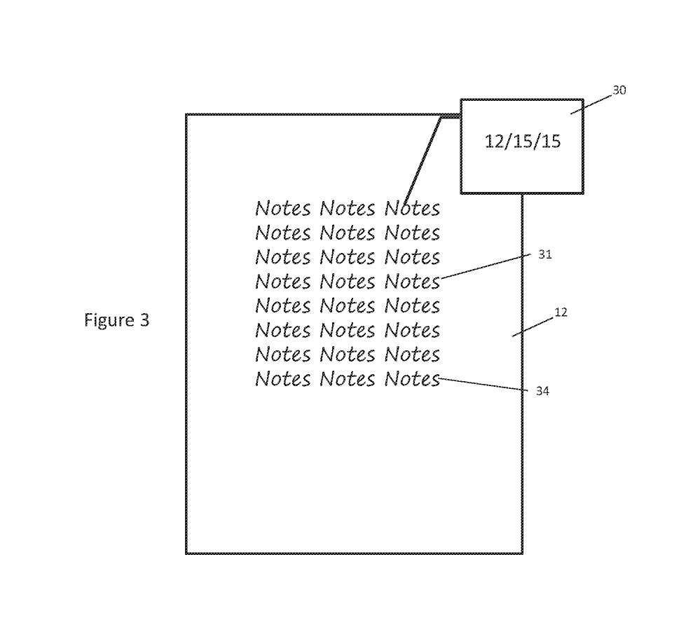

For example, if the encoding ink reservoir 18 includes UV or IR ink, one or more dispensing parameters might pertain to an amount of UV or IR ink that is allowed to flow from encoding ink reservoir 18 to the readable surface 12 via dispensing tip 20. In a simplest instance, the processor 24 (based on pre-programming or encoding data received) may communicate a desire for a written message to be free of any supplemental encoded information (such as is represented in FIG. 2, which will be discussed in greater detail below). This “no encoding” parameter may also simply be a pre-programed default that is in effect when the processor 24 receives no data or is deactivated. However, when supplemental encoded information is desired (such as is represented in FIG. 3, which will also be discussed in greater detail below), it may be imparted to the readable surface 12 and detected as follows.

As mentioned above, if the parameter implemented is a “no encoding” parameter, the written text 34 will be applied via ink from the standard ink reservoir. If the detecting sensor 32 were to be directed at the written text 34, there would be no supplemental encoded information detected (represented as “null” in FIG. 2). However, if a supplemental encoded information is desired based on encoding data received by the processor 24, an encoded message parameter will be implemented, and encoded UV or IR ink from the encoding ink reservoir 18 will be dispensed. When selected, the encoded message parameter includes communication between the processor 24 and the flow sensor 36, whereby the processor 24 may select the ink to be dispensed in conjunction with ink dispensing valves 38 and 40. For example, when implementing an encoded message parameter, standard ink valve 38 may be shut off, while the encodable ink valve 40 is opened. As the encodable ink 31 is dispensed, the flow sensor 36 provides information to the processor 24 pertaining to the extent of supplemental encoded information (such as information 30) that has been dispensed. Notably the flow sensor 36 may be employed to provide feedback to the processor 24 pertaining to the speed at which the writing device 10 is moving across the writing surface 12. This feedback may be used by the processor 24 to control the valves 38 and/or 40 to increase, decrease, or maintain an ink flow bit rate. This type of sensor/processor feedback loop also allows for monitoring of ink mixture composition to determine if more/less of one ink or another (for example from reservoir 16 or 18) is needed to properly encode given supplemental information.

In some exemplary instances, it should be appreciated that the encodable ink 31 dispensed onto the readable surface may be invisible or not fully decodable to the unaided human eye. In such instances (and even in instances where the supplemental encoded information is fully visible to the unaided human eye), the supplemental encoded information, such as that represented as information 30 in the written text 34 provided in encodable ink 31 as shown in FIG. 3, may be detected via detecting sensor 32, which, in an exemplary embodiment is one or more light source 46 and camera 48. When UV or IR ink is used, (like in FIG. 1), the light source may illuminate (via visible or non-visible light) the various UV or IR pigments present in the ink 31 on the readable surface 12, with the camera capturing supplemental encoded information therein.

In an exemplary embodiment using UV or IR ink, such as is shown in FIGS. 1 and 3, the detecting sensor 32 may be used in conjunction with a binary (or more generally base-K) encoding system achieved by detecting the presence or absence of UV or IR ink in prescribed bands. For example, if binary encoding and UV ink are chosen, a 0 might be encoded as the presence of ink in the 300-400 nm band, and a 1 as the presence of ink in the 200-300 nm band, and a 2 as the presence of ink in both bands. As mentioned above, the absence of any UV ink (or lack of UV ink in a specific band or bands, or lack of change in bands) would mean that there is no additional information being encoded at that moment. Analogously, a binary encoding for IR ink could be achieved by encoding a 0 as the presence of ink in the 0.8-2.5 micrometer band and an encoding of a 1 as the presence of ink in the 3.5-25 micrometer band, and a 2 as the presence of ink in both bands. Again, the absence of any IR ink (or lack of IR ink in a specific band or bands, or lack of change in bands) would mean that there is no additional information being encoded at that moment. Words or messages within the supplemental encoded information may also be indicated as ending via a termination indicator detected by identifying specific UV or IR bands present in the ink.

Presence of the base K representing bands in the dispensed ink 31 is controllable via the processor 24 as instructed by the pre-programmed or received encoding data, with the bands being detectable via the detecting sensor 32. In an exemplary embodiment, the detecting sensor 32 may be in communication (wirelessly or otherwise) with the processor 24 and/or the auxiliary computing device 25, wherein the binary sequence sensed by the detecting sensor 32 may be deciphered and displayed as the supplemental encoded information 30 at the input and/or display component 28 of the writing instrument 10 and/or a display component of the auxiliary computing device 25.

Notably, it should be appreciated that a readable surface or standard readable surface as used herein is defined as any writing surface that can receive ink from a typical pen or marker. While so called “smart” paper would certainly be usable with the writing device 10, and method(s) and system(s) for using the writing device 10 as described herein, this type of smart paper (or paper enhanced in any way at all) is not necessary to the dispensing of supplemental encoded information or detecting and interpreting of the supplemental encoded information (such as supplemental encoded information 30). Indeed, a readable surface or standard readable surface as used herein will be inclusive of any paper products without non-repeating dot patterns. Similarly, any readable surface or standard readable surface as used herein may include any surfaces of tables, walls, boards, or any other surfaces that can receive ink, along with erasable type “whiteboard” material (though not necessarily white) or Plexiglas type material that may receive ink from a typical dry erase or permanent marker.

In addition, while the supplemental encoded information 30 in FIG. 3 is shown as a date, the encoding of various other types of information might be useful and are considered herein. For example, information pertaining to location (GPS, iBeacon, or WiFi signal information), time (local time and/or global time clock time), writing device identification, location of the writing itself (page number, line, etc.), and author may all be represented in supplemental encoded information such as information 30. It should be appreciated that the writing device 10 may also include an internal clock that communicates with the processor 24 to encode timestamps in the supplemental encoded information 30. In addition, the encoding data received by or programmed into the processor 24 may be instructive of time interval between delivery of various bits of supplemental encoded information. For example, supplemental time information may be encoded in and along the written message every two seconds, or supplemental author information may be encoded in and along the written message every three seconds, or supplemental date information may be encoded in the written message as soon as writing commences, within the next 5 seconds, or until a subsequent command supersedes this one.

Further, while the exemplary embodiment of FIGS. 1-3 employs a type of ink chemistry in order to dispense supplemental encoded information in a handwritten message (i.e. ink with UV or IR pigment), it should be appreciated that other provisions for dispensing such information are considered in this disclosure. Indeed, varying stroke width as controlled by the processor 24, or provision in an encoding reservoir and dispensing of encodable ink with particles of varying magnetic polarity, varying nano-materials, or varying distinctive texture materials found in the ink dispensed on the readable surface can all be used in conjunction with appropriate sensors and the binary system discussed above to impart and detect supplemental encoded information such as information 30.

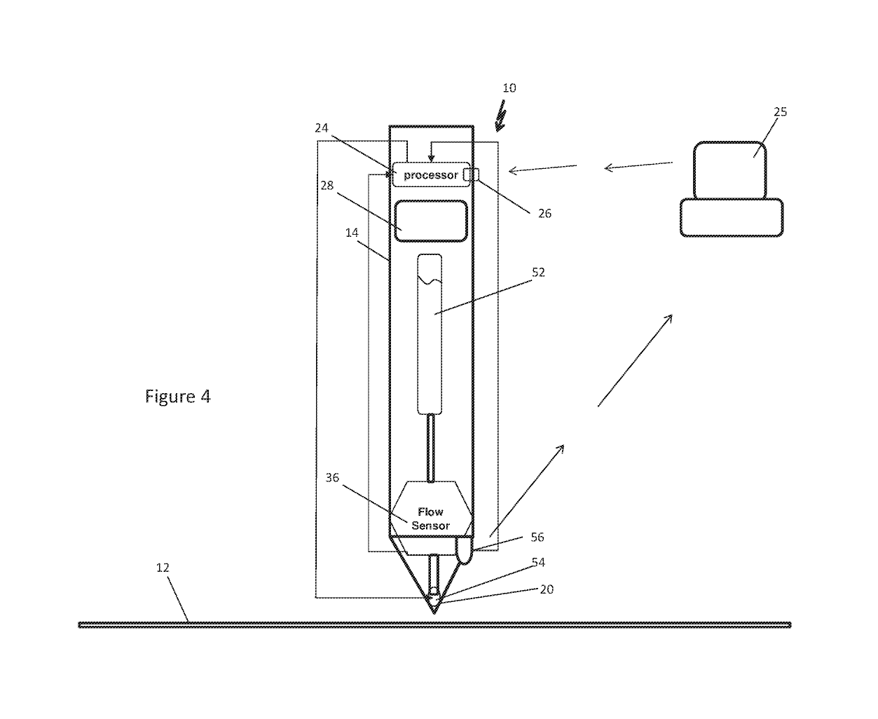

One such example is shown in FIG. 4, wherein an “electronic ink” (with bi-colored charged materials like in e-ink) or ink with metal fragments is employed by the writing device 10. In such an additional exemplary embodiment, an “extra” encoding ink reservoir would not necessarily be employed. Indeed, a single encoding ink reservoir 52 wherein all of the ink includes charged, magnetic or metallic particles/fragments may be employed. When the processor 24 is instructed to dispense in accordance with a “no encoding” parameter (again, perhaps the default) or an encoded message or messages parameter(s), the processor could control an electrode, small magnet, or electromagnet 54 disposed at the dispensing tip 20 in a manner that prevents/slows/reorients/modulates/repositions dispensing of magnetic, polarized bi-colored or metallic particles in the ink. In this manner, a magnetic detecting sensor 56 (or IR/UV detecting sensor in the case of bi-colored material) could be used to relay binary sequences similar to those discussed above to the processor 24 of the writing device and/or auxiliary computing device 25 for similar display.

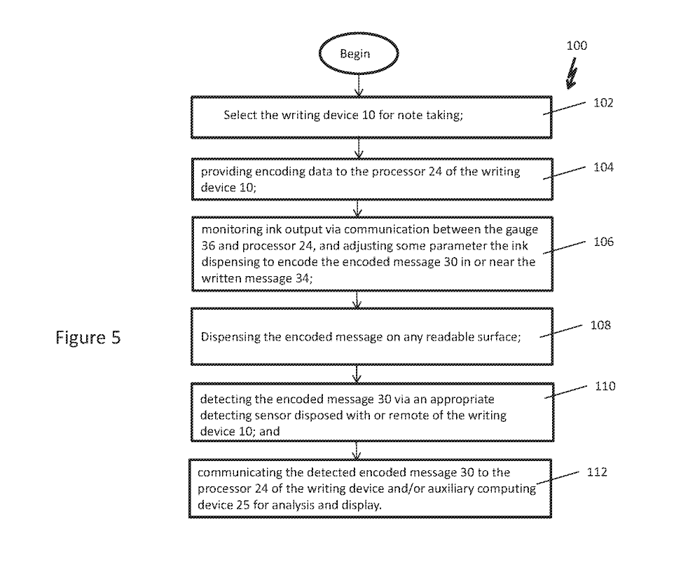

With reference to FIG. 5, an exemplary process or method 100 describing usage of a writing device 10 as shown in FIG. 1 or 4 (or other embodiments) follows below. First, and as shown at operational block 102, during the process of note taking a user may select the writing device 10 to record notes on ordinary paper or similar ordinary readable surface (i.e. any readable surface). This may be done in the normal course of preparing to take notes without taking special measures.

As shown in operational block 104, the method 100 further includes provision of encoding data to the processor 24 of the writing device 10 (possibly prior to the meeting). This data includes instruction as to what information it is to be encoded in the supplemental encoded information 30 during the inking.

As shown in operational block 106, the method 100 also includes monitoring ink output via communication between the flow sensor 36 and processor 24, and adjusting some parameter the ink dispensing to encode the supplemental encoded information 30 in or near the written message 34. As discussed above, possible vehicles for performing this encoding include ink chemistry (UV or IR), stroke width, ink magnetic polarity, inserted encodable nano-materials, distinctive semi-random texture materials, etc. As is shown in operation block 108, the ink with the supplemental encoded information is then actually dispensed on the readable surface 12, with the readable surface being any surface that will accept the ink.

As shown in operational block 110, the method 100 further includes detecting the supplemental encoded information 30 via an appropriate detecting sensor disposed with or remote of the writing device 10. If with the writing device 10, this sensing/detecting is accomplished by pointing the detecting sensor on the device 10 at the written message 34, or stroking over a short segment of the written message 34.

As shown in operational block 112, the method 100 still further includes communicating the detected supplemental encoded information 30 to the processor 24 of the writing device and/or auxiliary computing device 25 for analysis and display.

Any flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A device for encoding information written on a readable surface, the device comprising:
a device housing comprising a main section and a tapered section and containing first and second ink reservoirs in the main section;
a first valve contained within the main section and comprising a first part, which is coupled to and disposed within the first ink reservoir with an absence of a tubular element interposed between the first part and the first ink reservoir, and a second part, which is disposed at an exterior of the first ink reservoir;
a second valve contained within the main section and comprising a first part, which is coupled to and disposed within the second ink reservoir with an absence of a tubular element interposed between the first part and the second ink reservoir, and a second part, which is disposed at an exterior of the second ink reservoir an ink dispensing tip contained within the tapered section and connected with the respective second parts of the first and second valves and thus communicative with the first and second ink reservoirs via the first and second valves; and
inks respectively stored in the first and second ink reservoirs and configured to flow from said ink dispensing tip, one of said inks being encodable to include supplemental encoded information, said supplemental encoded information being detectable by at least one detecting sensor when dispensed on the readable surface,
wherein the readable surface is any surface that will accept said ink, and
wherein said supplemental encoded information is provided in said inks via at least one of ink chemistry, stroke width, ink magnetic orientation, presence of encodable nano-materials, bi-colored charged materials, and distinctive texture materials found in said inks dispensed on the readable surface.

2. (canceled)

3. (canceled)
